(19) United States
(12) Patent Application Publication
(10) Pub. No.: US 2019/0113225 A1
(43) Pub. Date: Apr. 18, 2019

(54) Method to Enhance Burner Efficiency and Burner

(71) Applicant: Dynamis Engenharia e Comércio Ltda., Sao Paulo (BR)

(72) Inventors: Guilherme Martins Ferreira, Sao Paulo (BR); Luis Filipe von Rainer Fabiani, Sao Paulo (BR); Luiz Felipe De Pinho, Sao Paulo (BR); Rodrigo De Sousa Borges, Sao Paulo (BR)

(21) Appl. No.: 16/090,369

(22) PCT Filed: May 10, 2017
(86) PCT No.: PCT/BR2017/050111

§ 371 Date: Oct. 1, 2018

(30) Foreign Application Priority Data
May 11, 2016 (BR) BR102016010608-7
May 9, 2017 (BR) 10 2017 009706 4

(51) Int. Cl. F23D 1/00; F23D 1/04; F27B 7/10

(52) U.S. Cl. CPC F23D 1/005; F27B 7/10; F23D 1/04

(57) ABSTRACT

A burner barrel includes a concentric multi-tubular structure, formed by pipes and at the end downstream the burner barrel is provided a burner tip in which various nozzles to inject fuel and primary air are perforated. The burner tip includes at least one series of nozzles intended to inject an external air flow; a second series of nozzles intended to inject tangential air flow; and a third series of apertures intended to inject the fuel and transport air. The ends downstream of the first and second burner pipes are joined and define a continuous external annular surface of the burner tip. The nozzles are arranged within an inscribed area, being the dimension of the nozzles limited by a rate between the open area A of the nozzles and the complementary closed area A.

The present invention relates to improved burners to be used in cement production kilns.

### STATE OF ART

As it is well known, the cement production consists, briefly, from the steps of raw material extraction; grinding, mixing and homogenization; clinkerization in rotary kilns; clinker cooling; grinding and bagging the produced cement.

Among these steps, the most critical is the mentioned clinkerization of the previously homogenized mixture, which is carried out in large, cylindrically shaped rotary kilns, provided with controlled burners in order to establish a suitable temperature in each rotary kiln's region. Considering this focus, two fundamental aspects regarding the mentioned burners stand out: the energy efficiency and the promptness in the thermal responses.

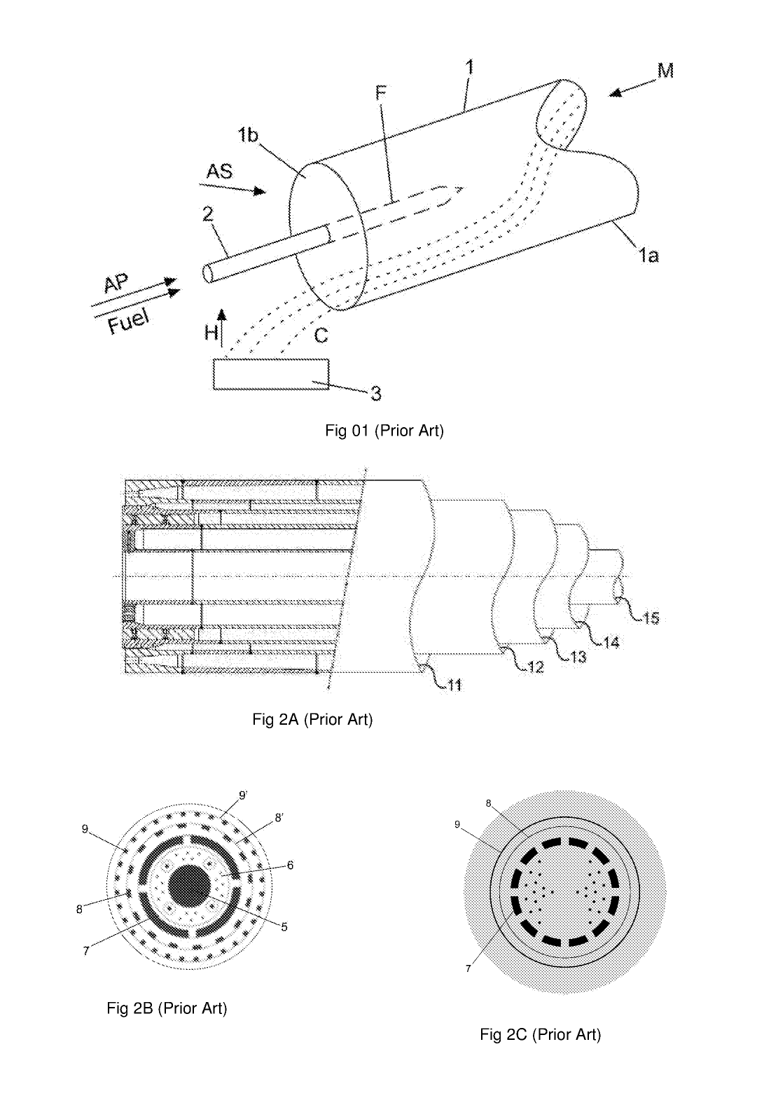

An example of a rotary kiln is illustrated, schematically, in FIG. 1. In said figure, a rotary kiln is indicated with the number (1) and it is intended to burn said pre-homogenized mixture (M) in counter-current. With the number (2), is indicated a burner, which is fed upstream with primary air (Ap) and fuel, for example, coke, coal or others. The clinker cooler is indicated with the number (3), which receives the hot clinker resulting from the mixture (M) burning and coming from inside the kiln (1). In the present systems, the heat released from the cooler (3) is transferred to the secondary air flow (As), thus reaching temperatures around 1000° C. In operation, the burner (2) is turned on (ignition of the air/fuel mixture) and kept working until the kiln (1) temperature reaches a pre-determined value, which is around 1000° C. in the material (1a) feeding region. At this moment, the homogenized mixture (M) is fed, in rotation, into the kiln (1) upper end (1a), and it moves towards the kiln outlet lower end (1b). Once the burner is positioned in the central region of the kiln (1) lower end (1b), the flame (F) created by the fuel combustion is driven toward the interior of the kiln (1), generating larger temperature gradients around the end (1b) and smaller temperature gradients around the end (1a) of the kiln 1. Therefore, the mixture (M) advance is towards the higher temperatures.

After the mixture (M) burning step, then transformed into clinker (C), such material is dumped into a cooler (3) positioned below the kiln (1) outlet. The heat (H) emanated from this cooler (3) heats the secondary air flow (As), which is mixed with the air and fuel flows injected by the burner (2), thus forming the flame (F). It should be noted that the secondary air flow is either blown through the cooler (3) or sucked into the kiln (1) by an exhaust fan.

In particular, it should be clarified that the injection velocity of the primary air (Ap) and fuel inside the kiln (1) to generate the flame (F) is quite relevant, reaching speeds of hundreds of meters per second. As a result, a low pressure is generated in the kiln lower end (1b) region, thus leading to hot air or secondary air (As) entrainment. It should be further noted that such secondary air flow (As), as it is known, is essential to the formation and thermal behavior of the flame (F). In addition, the current design techniques for burners are based on supplying primary air (Ap) in a quantity lower than the stoichiometric ratio for fuel burning, being the remaining air supplied in excess (poor fuel air ratio), by secondary air flow (As).

An example of a clinker burner is that described in EP 0628768. Such document describes a burner specifically intended to burn solid fuels, such as fine coal powder, injecting air (15) and fuel (12) through their respective internal ducts (10, 17).

Particularly in regard to burners for cement production, the burners currently available on the market have a basically cylindrical configuration composed by concentric pipes, as shown in FIGS. 2A, 2B and 2C. As a result of this concentric geometry, the burner tip (FIGS. 2B and 2C) has a series of annular regions provided with respective nozzles and/or apertures, in pre-determined quantities, through which primary air flows and/or fuel are injected for burning. Specifically, the most commonly used types of burners are annular (FIG. 2C) and multi-channel (FIG. 2B) with discrete air injectors.

Regardless of the burner's type or, specifically, of the burner head configuration, the burner body (2) is defined by a series of concentric cylindrical tubes (11-15), FIG. 2A), wherein between each pair of adjacent pipes is defined an annular injection zone. Whatever the burner's type (2), the annular channels are shown in FIGS. 2B and 2C and comprise: external air flow (9); tangential air flow (8); and conveying air and fuel (7) flow. The innermost annular zones are left for feeding an internal primary air flow (6) and liquid/solid waste fuels (5), that are not always used.

In particular to the annular section burner head (FIG. 2C), the apertures for external (9) and tangential (8) flows are in the form of annular apertures, whereas in the multi-channel burner head, the apertures for external (9) and tangential (8) flows are defined by radially arranged nozzles. In addition, in the multi-channel burner head, there are also provided gaps (9′, 8′) resulting from annular interspaces between the concentric cylindrical elements (11, 12) and (12, 13), respectively, as a function of the expansion of each of concentric cylindrical tubes (11-15).

Finally, the flame characteristics result from the configuration adopted for the burner (design configuration), i.e. the rings and/or the number of orifices in each ring configuration, as well as the fuel nature, oxidant, feed pressure of the various primary flows (Ap) (operational parameters), and others. In addition and as already mentioned, such configurations and parameters are also directly related to the intensity of the secondary air flow (As), which is entrained by the burner as a function of the primary air flow (Ap).

### BACKGROUND OF THE INVENTION

Therefore, and with the purpose of enhancing the burner performance, the inventors have developed a series of specific studies.

These studies have shown that the main parameter capable of significantly enhancing the burner performance is associated with secondary air entrainment in the first initial meters of the flame (by primary air flow).

Analyzing deeply this secondary air suction phenomenon by the burner, it was possible to isolate three main variables:
primary air flow;
primary air injection velocity; and
primary air injection geometry.

Hence, whereas the features related to primary air mass flow and injection velocities of each individual primary air portion are operational parameters, the geometry changing of nozzles and/or injection gaps of the individual primary air flows of a burner in operation is very difficult to design and execute, in view of the high temperatures and materials used. In the very few cases, wherein the burner presents this factory option, during its operation the employed mechanisms do not withstand the extreme conditions inside the clinker kiln.

In addition, the design phase of a burner, and in particular of the burner head configuration, is a rather complex and time-consuming phase. Usually, once the future operating conditions of a kiln are defined, the designers begin to develop the burner according to said operating conditions, testing every possible configuration supported by powerful Computational Fluid Dynamics (CFD) software. Obviously, and as it is clear to any expert in the art, the traditional design procedure can involve a significant amount of processing hours, increasing the total time and the project costs.

### OBJECTS OF THE INVENTION

A first object of the present invention is a method for increasing the efficiency of burners for cement kilns by rationalizing the burner design phase.

It is a second object of the invention a method capable of providing a burner operational behavior prediction, based on dimensionless factor.

A third object of the invention is a burner for rotary kilns to produce cement, wherein the dimensional features of the primary flows injection nozzles result from a dimensionless factor.

### DESCRIPTION OF THE INVENTION

It has been surprisingly discovered by the inventors that the design conventional methodology can be advantageously simplified by replacing the Computational Fluid Dynamic—CFD simulations of the burner head configurations by a simple mathematical formula. More specifically, and from the combination of the inventors' experience and numerous Computational Fluid Dynamic CFD simulations, it was possible for the inventors to generate a simple mathematical formula (equation 1) and a simplified method for testing the feasibility and efficiency of a burner.

As a result of various tests performed using the developed methodology, it was also possible for the inventors to define certain innovative features for rotary kiln burners for cement production, allowing greater secondary air entrainment and, therefore, a more efficient fuel-burning by the primary and secondary air flows.

In particular, the present invention relates to a burner to be used in cement rotary kilns and comprising a concentric multi-tubular structure, formed by pipes between which are defined respective cylindrical feeding channels, wherein at the end downstream the burner barrel is connected to the burner tip (also known as burner head) in which the various fuel and primary air injection nozzles are perforated, whereas at the end upstream the burner barrel are arranged the connection means with the fuel and primary air sources, and wherein said burner tip comprises: a first series of nozzles intended to inject an external air flow; a second series of nozzles, with an annular arc section, and intended to inject a tangential primary air flow; a third series of apertures, with an annular arc section, and intended to inject fuel and transport air. In addition, the ends' downstream the first and second burner pipes are joined together and define, each other, a continuous external annular surface of the burner barrel, wherein between the first tube and the second tube is defined an external air flow feeding channel, said circular cross-section nozzles being disposed within an inscribed area, which is externally bounded by a radius Re outer circumference, which is tangent to the radially outermost point of each one of the nozzles, and it is internally bounded by a radius Ri inner circumference, which is tangent to the radially innermost point of each one of the nozzles, wherein in said inscribed area the ratio between the nozzles open area Ao and the closed area Ac is limited to: 0.12<Ao/Ac<0.27; wherein the open area Ao corresponds to the sum of the areas of each nozzle multiplied by the number of the burner head nozzles and the closed area Ac corresponds to the inscribed area minus the open area Ao. In particular, the ratio between the nozzles open area Ao and the closed area Ac is limited to: 0.19<Ao/Ac<0.25. An expansion joint is disposed in the region between the end upstream the second tube and the flange. Alternatively, the expansion joint is disposed in the region between the end upstream the first tube and the flange.

The object of the present invention will be better understood and defined from the following detailed description, which is made related to a particular non-limiting embodiment of the invention and based on merely exemplary figures in which:

FIG. 1 is a partial schematic view of an equipment group for cement production, comprising kiln, burner and cooler, according to the state of the art;

FIG. 2A is a partially sectioned side view of a burner, according to the state of the art;

FIG. 2B is a front view of a multichannel burner head with discrete injectors of a burner, according to the state of the art;

FIG. 2C is a front view of an annular burner head of a burner, according to the state of the art;

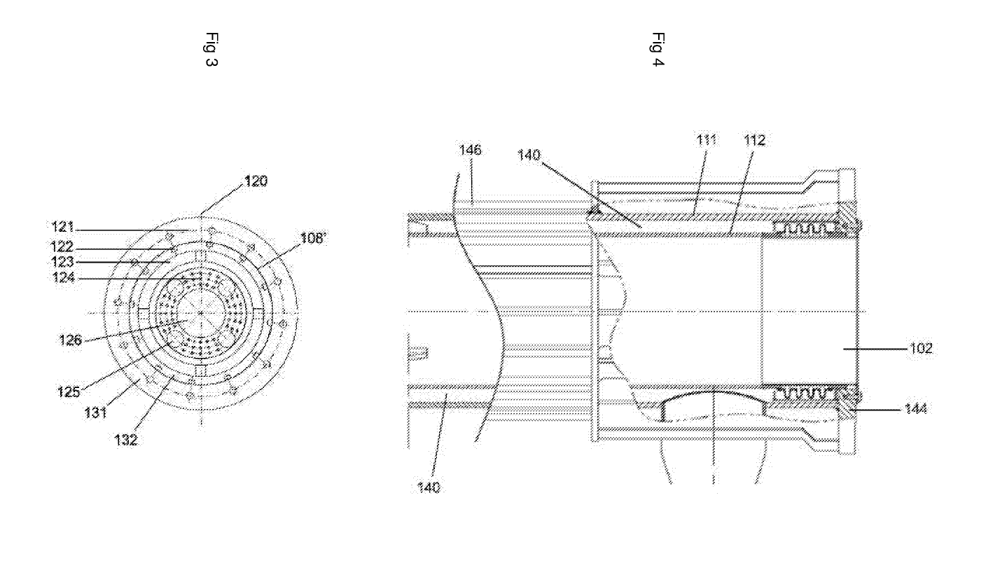

FIG. 3 is a front view of a burner, according to the present invention;

FIG. 4 is a sectional side view of the burner body of the invention, showing the expansion joint;

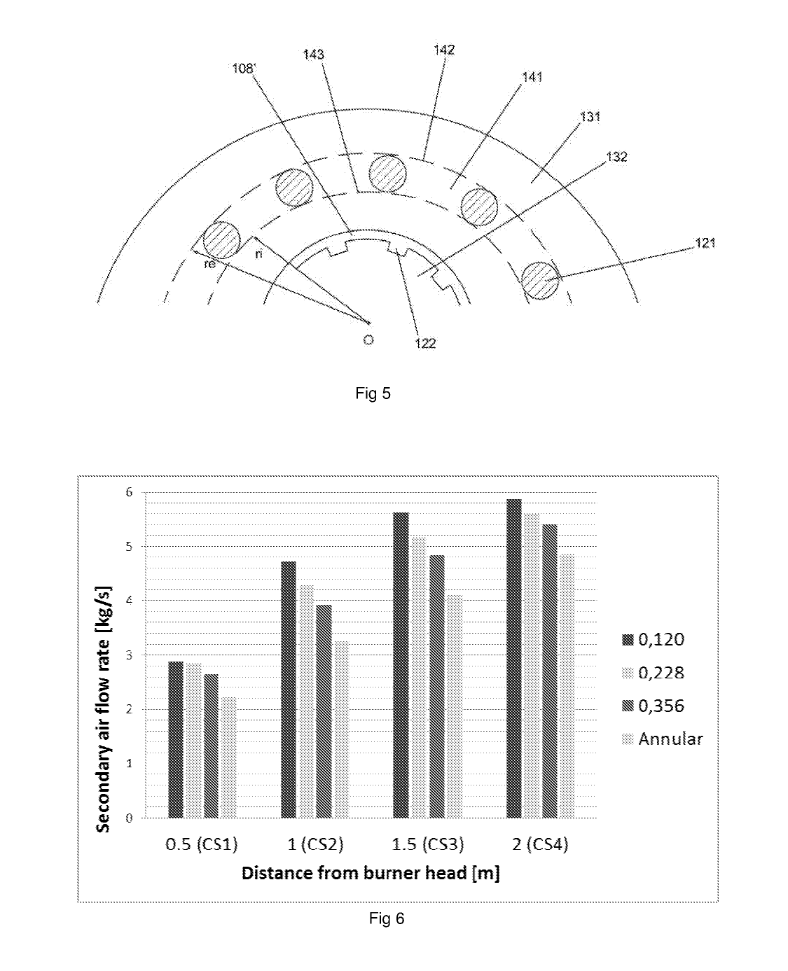

FIG. 5 is a schematic and out-of-scale view showing the outermost annular region of the burner head and the external air outlet nozzles;

FIG. 6 is a graph showing the total secondary air flow (As) measured in determined planes (CS) from the burner head, comparing three solutions of the invention with an annular burner of the state of the art;

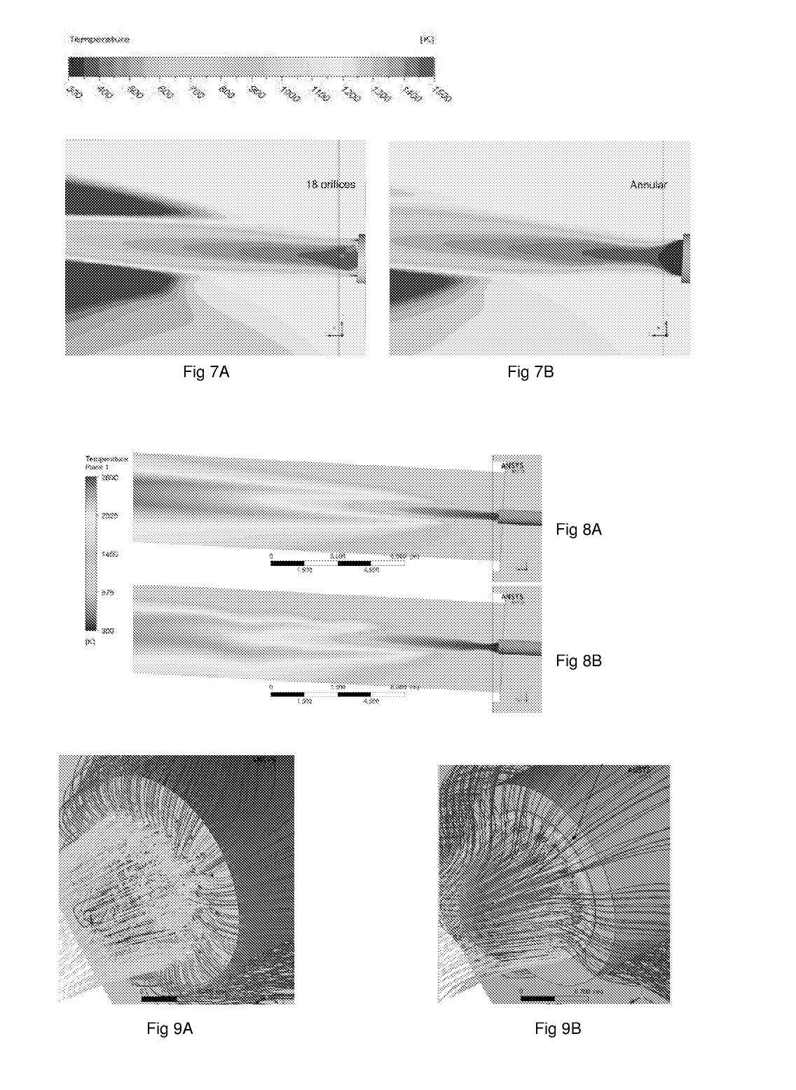

FIGS. 7A and 7B are Computational Fluid Dynamic—CFD plots showing the flame F shape, respectively, for the burner head of the present invention and for an annular burner head;

FIGS. 8A and 8B are Computational Fluid Dynamic—CFD plots showing the temperatures profile inside a kiln fed from burners provided with burner heads, according to the present invention and according to those of annular type, respectively;

FIGS. 9A and 9B show, by images also generated by Computational Fluid Dynamic—CFD, the dynamic behavior of the primary and secondary air flows lines obtained from the burner heads of the invention as well as by those of annular type; and

FIGS. 10A and 10B are 200-magnification microscopy images of the clinker produced, respectively, in kilns provided with burner having burner heads according to the invention and in annular type burners, according to the state of the art; and

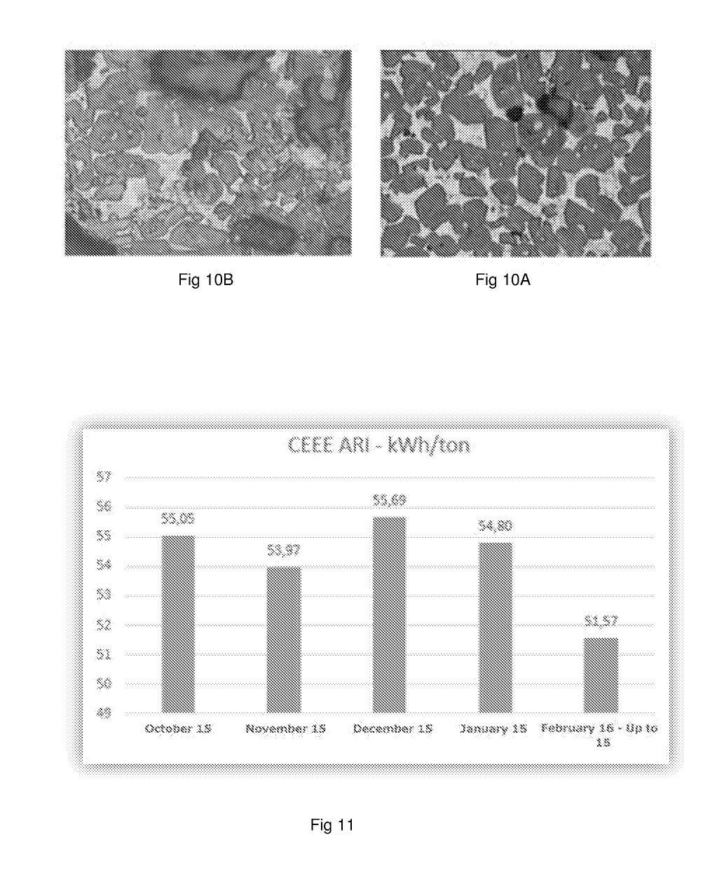

FIG. 11 shows a bar graph indicating the energy amount required for milling the clinker produced by the testing industrial unit, before and after replacement of the prior art burner head by the burner head according to the invention.

### DETAILED DESCRIPTION OF ONE EMBODIMENT OF THE INVENTION

As a result of the tests and researches carried out by the inventors, it was possible to ascertain an index (Geometrical Index or Ig) and, therefore, a respective method, in order to evaluate the burner performance, making possible to resize the functional characteristics thereof seeking, in a simple and practical way, an enhancement in its performance.

According to the present invention, the proposed method includes determining a dimensionless geometrical index Ig, which is calculated from the following formula:

$${I}_{g} = C \frac{{dD}_{h}}{{RD}_{h \_ eq}} \qquad ( Equation 1 )$$

wherein:
D=is the distance between external orifices;
Dh=is the external air channel hydraulic diameter;
R=is the distance from the center of the burner head to the center of the external air channel;
Dh_eq=is the equivalent annular hydraulic diameter of external air channel area; and
C=is a constant

From the herein proposed index (Ig), it is possible to selectively vary in dimension the various constructive parameters of the burner, as well as its functional parameters, in order to obtain a simple, practical and direct response to the expectation of its functional efficiency. In this case, it should be emphasized that the proposed index is an auxiliary mode of evaluation, but it is not intended to eliminate studies by means of mathematical models, known as complex ones.

For example, from a design in progress, it is possible to use the geometrical index (Ig) to adjust the number of orifices of a certain primary air portion. Practical tests have shown that by using such an index, an increase in the volume of secondary air entrained by the burner is obtained, as the proposed distribution reveals a better geometrical index (Ig).

In particular, the method of the present invention comprises the steps of:
to design a burner in accordance with the kiln's operating requirements;
to calculate the burner geometrical index (Ig), according to the defined design features;
to enhance the burner's performance from the variation of the burner construction parameters and recalculation of the geometrical index (Ig) for the alternative constructive arrangement; and
to use the burner in an arrangement that has the best geometrical index (Ig).

Specifically, and already defined the operational and physical features of a rotary kiln for cement production, it is possible to determine which are the burner operating parameters responsible for the clinkering of the mixture fed into said kiln. In accordance with these burner features, the designers establish, among others, one or more possible configurations for the fuel injection apertures and, especially, the injection nozzles of the external and tangential flows portions of primary air. It should be noted that, as already mentioned, the configuration adopted for such injection nozzles is mandatory regarding to the secondary air suction volume, which in turn is liable for igniting the air/fuel mixture and for forming the resulting flame.

Subsequently, the proposed configuration is tested using the formula (equation 1), from which results a dimensionless Geometrical Index (Ig) and proportional to the burner efficiency. Therefore, alternative configurations for said primary air injection nozzles arrangement are proposed, and for each arrangement the geometrical index (Ig) is again recalculated. Thus, as it is clear to those experts in the art, the comparison between calculated geometrical indices (Ig) is used to select the best configurations as well as to direct the development of other nozzles configurations. Obviously, in the process of developing a configuration for the air and fuel injection nozzles, the first alternatives are chosen according to the engineer's expertise in charge for said development. Based on this configuration and the respective ascertained geometrical index (Ig), the engineer can vary one of the arrangement/configuration parameters of a kind of nozzle, evaluating a possible improvement or not in the resulting geometrical index (Ig).

Once a configuration is selected, it can be subjected to a second compliance checking, using the conventional Computational Fluid Dynamics—CFD technique.

As point out above, the design methodology herein proposed greatly expedites the design step of configuring the burner head, i.e., the arrangements (number, dimension and position) for the various ejection nozzles of the fuel mixture components.

Finally, as a result of several studies and simulations carried out by the inventors, it was possible to determine that certain constructive features of the burner, and in particular of the burner head, result in a higher thermal efficiency of the system, as well as greater operational control of the flame.

FIGS. 3 and 4 show, respectively, front and side sectional views of a burner according to the present invention. As already mentioned the burner barrel (102) is a concentric multi-channel structure formed by pipes (111-115) and between which air channels are defined. At the downstream end, the said burner barrel (102) is connected to its burner tip (120) in which the various nozzles of fuel and primary air (AP) are placed.

With particular reference to the burner tip (120), it has: a first series of nozzles (121) of circular cross-section and intended to inject an external air flow; a second series of nozzles (122), with an annular arc section and intended to inject the tangential air flow; a third series of apertures (123), with an annular arc section, to inject fuel and its conveying air. Alternatively, according to the state of the art, can also be provided, in the radial direction and towards the center of the burner, a plurality of injection nozzles (124) of internal primary air flow, alternated with liquid fuel injectors (125), and, centrally, an aperture (126) for injection of solid waste and its conveying air.

In addition, the burner head (12) can be defined from a number of concentric pieces, or annular structures. Accordingly, in the outermost radial position, an external annular channel (131) is defined, in which said nozzles (121) of the first series (external air) are machined (perforated). Internally to the said external annular channel (131) is defined the tangential annular channel in which the nozzles (122) of the second series (tangential air) are formed. Internally to the mentioned annular surfaces, described above, further annular channels are formed, but they are not relevant to the scope of the present invention, being this the reason why they are not shown.

Between the external annular surface (131) and the tangential annular surface (132) there is a gap (108′) to separate said surfaces (see specifically FIG. 5), the function of which is to allow differential displacement between the pipes (112, 113), as will be described below. As a result of the presence of the gap (108′), the tangential primary air flow is mostly injected by said nozzles (122) of the second series of nozzles, whereas a small portion of this tangential flow is released through said gaps (108′). At this point, it is important to point out that the minimum portion of the tangential air flow escaping through the gap (108′) does not affect the flame (F) shape, even though the use of the equipment result in an increase in the radial dimension of the gap (108′) over time. The lower impact of the tangential air flow through gaps were investigated and the inventors discovered that this fact is related to the lower injection pressure of the tangential air (when compared with the external air).

On the other hand, the various studies carried out by the inventors have shown that the gap (9′), existing in the burner tips currently in production and use (see FIG. 2B), significantly affect the flame (F) shape and said negative effect is exponentially increased over time, i.e. in view of the increase of the gap (9′) radial dimension as a function of the external primary air flow passage therethrough.

Accordingly, and as a first innovative feature of the burner (102) of the present invention, the ends downstream the first (111) and second (112) burner tubes (102) are joined and define, each other, said annular surface (131). More particularly, between the first pipe (111) and the second pipe (112) is defined a channel (140) to conduct the external air flow, which has an inlet upstream (not shown) and injection nozzles (121).

With regard to said nozzles (121), it has also been surprisingly discovered that it is possible to define a total annular area which inscribes said nozzles (121), and within this area a correlation between the closed areas (closed surface) and the open areas (of the nozzles 121) and, by maintaining this correlation controlled, it is possible to optimize the flame (F) shape produced by the burner tip (120). More particularly, and in regard specifically to FIG. 5 (partial, schematic and off-scale for better visualization), it is possible to calculate an open area Ao (corresponding to the sum of each of the nozzles (121) areas multiplied by the number of burned tips (120) nozzles) and a closed area Ac (corresponding to the inscribed area (141) minus the open area Ao), being this calculation accessible to any expert on the art.

Specifically, and as discovered by the inventors, such a ratio between the nozzles (121) open area Ao and the closed area Ac should be limited to the following range: 0.19<Ao/Ac<0.25.

From various simulated tests (using Computational Fluid Dynamics—CFD), it was possible for the inventors to confirm the full viability of the herein mentioned established ratio, as well as, mainly, an enhancement in the burner operating conditions, and, consequently, in the kiln (1) for cement production.

Finally, in order to allow the mentioned connection between the two outermost pipes (111, 112), the inventors proposed the inclusion of an expansion joint, as is particularly shown in FIG. 4.

FIG. 4 shows a longitudinal sectional view of the burner (102) barrel, according to the present invention. For the sake of clarity, the representations of the pipes (113-115) were omitted from the portion downstream (on the left, in FIG. 5) the burner barrel (102). In particular and as already mentioned, the first radially outermost pipe (111) extends itself from the flange (144) to the opposite region, in which the burner tip (120) of the burner barrel (102) is fixed. Said flange (144) is provided to fix the various primary air and fuel supplying ducts Ap in the plurality of cylindrical annular channels which are defined between each pair of adjacent ducts. In particular, FIG. 5 illustrates only the annular configuration channel (140), which is laterally delimited by the first and second pipes (111, 112), at downstream by said flange (144) and at upstream by the inner wall of the external annular surface (131), which connect the first pipe (131) to the second pipe (132). In the illustrated embodiment, said second pipe (132) is shorter than the first pipe (131), i.e., not reaching to said flange (144). In the region between the end upstream the second pipe (132) and the flange (144) is provided an expansion joint (145), which allows a relative movement between the pipes (131, 132) due to the differences in operating temperature. As it is known to those experts in the art, the first pipe (131) is submitted to a higher temperature relative to the second pipe (132), despite the existence of an insulating ceramic cover (146) directly placed around the first pipe (131). The origin of this first pipe (131) higher temperature is the heated secondary air flow As (t≈1000° C.), as well as the radiation emanating from the clinker layer inside the kiln (1).

Alternatively, the first pipe (131) may be shorter than the second pipe (132), which projects itself into the flange (144). In this case, and similarly, at the end upstream the first pipe (131) is installed the expansion joint (145), thus also allowing the differential movement between both pipes (131, 132).

### Tests

The burner (102) of the present invention was installed, in order to develop a field test, at Rio Branco's Votorantim Cimentos plant in the beginning of 2016. In particular, such an industrial plant was selected for the field tests since it already has a burner manufactured by the present applicant, and this allowed the simple burner tip replacement by a new one in accordance with the present invention. More specifically, said installed burner tip has 18 nozzles (121) for injection of the external primary air flow (Ap), with the Ao/Ac rate being 0.228. In addition, said installed burner tip also had 18 nozzles (122) for the tangential air flow, radially aligned with the external air nozzles (121), and opened against the gap (108′), as shown in FIGS. 3 and 4. The improvements and advantages arising from the burner tip, according to the invention, may be summarized in the items below and supported by the functional and operational comparisons shown in FIGS. 6 to 11, as follows:
Smaller C₃S crystals, therefore, greater clinker reactivity and resistance increasing of the produced cement;
Greater sulfur purge, i.e. lower production losses when using high sulfur content fuels (pet coke of 6.5% S);
Refractory useful life increase (by up to 30%); and
Kiln with more stable operation and faster response to the parameters changed by operators.

In particular, FIG. 6 illustrates, in the form of an inter-relating graph, the secondary air flow As entrainment into the region of the fuel injection according to control planes CS, which are respectively 0.5 m (CS1), 1.0 m (CS2), 1.5 m (CS3), and 2.0 m (CS4) away from the burner tip external surface. Specifically, said graph of FIG. 6 compares three configuration solutions of burner tip nozzles (121), according to the present invention, defined by 0.120, 0.228 and 0.356 Ao/Ac rates. In addition, the graph of FIG. 6 further illustrates the results for the secondary air flows obtained for an annular type burner tip (see FIG. 2C) in the same reference planes. As can be appreciated, and in any one of the measurement planes of the secondary air flows As, the configurations of the present invention indicate a greater secondary air entrainment into the region of the fuel injection and, therefore, resulting in a better flame (F) shape and a more efficient burning of the fuel introduced by the apertures (123).

Such a fact can be better appreciated from FIGS. 7A and 7B, wherein are shown the flame (F) shape and the respective temperature profile, from Computational Fluid Dynamics—CFD plots, for the burner tip of the present invention (Ao/Ac=0.228 with 18 nozzles (121) of external air injecting)—FIG. 7A—and for an annular burner head (FIG. 7B), according to the state of the art. In a complementary manner, FIGS. 8A and 8B show the temperature profiles inside the kiln, which respectively operate with burners provided with a burner tip of the present invention (Ao/Ac=0.228 with 18 nozzles (121) of external air injection) and for an annular burner tip, according to the state of the art. What is noted from the images herein referred is that the better flame (F) shape results in a better distributed temperatures profile and a more stable gradient inside the kiln.

Another important consequence of the better flame formation and the thermal profile obtained inside the kiln is related to the necessary time to achieve the kiln stabilization. Therefore, Table 1 below shows the dates in which the kiln of the Rio Branco industrial unit was reactivated after a scheduled stoppage. Among the dates indicated in table 1, the first (jan/16) is related to the operation after the burner head installation, according to the invention, being the others related to the stabilization times for a burner according to the state of the art.

TABLE 1
load and time for stabilization after scheduled stoppage
Table 1. Start-up after scheduled stoppage

[symbol]

| | Feeding stabilization | Time for stabilization |
|---|---|---|
| Date | (ton/day) | (h) |
| jan/16 | 3800 | 4 |
| jun/15 | 3600 | 12 |
| set/14 | 3600 | 6.5 |
| jan/14 | 3420 | 13.5 |
| mai/13 | 3220 | 5.5 |

As can be noted, the stabilization time of the kiln provided with a burner barrel with a burner tip, according to the invention, is substantially less when compared to the stabilization times previously obtained. In addition, using the burner of the invention, it was possible to increase the load of material treated by the kiln within the stability value. In other words, the burner barrel of the invention allowed a faster recovery and higher productivity of the kiln under study.

Finally, FIGS. 9A and 9B illustrate, also by means of images generated by Computational Fluid Dynamics—CFD, the dynamic behavior of the lines of the primary and secondary flows obtained by the aforementioned burner heads. By the analysis of these images, it is noted a more homogeneous distribution of the secondary air flow in the burner head of the present invention, as well as, mainly, a greater secondary air entrainment in the radially innermost region, resulting in a better combustion.

The final result can be observed from FIGS. 10A and 10B, which are images of the microscopy analyzes carried out of the clinker produced by the burner of the invention and by a burner of the state of the art. It is observed, from the comparison between the images of FIGS. 10A and 10B, that the C3S grains are more consistent in dimension and more homogeneously distributed, that is, indicating an improvement of the produced clinker. This can also be observed from the graph of FIG. 11. In this Figure, it is shown the power consumption during cement finish milling. The values presented in the production reports indicate a 10% power reduction, per ton of cement produced.

1. A burner, of the type used in rotary kilns for cement production, and comprising a concentric multi-tubular structure, formed by pipes and between which respective cylindrical feeding channels are defined, wherein a burner tip is provided at an end downstream a burner barrel in which various fuel injection and primary air nozzles are perforated, whereas at an end upstream the burner barrel are arranged connection means with fuel and primary air sources, and wherein said burner tip comprises: a first series of nozzles for injecting an external air flow; a second series of nozzles, with an annular arc section, and intended to inject tangential air flow; a third series of apertures, with an annular arc section, and intended to inject fuel and transport air, wherein:
the ends downstream the first and second pipes of the burner barrel are joined together to define a continuous external annular surface of the burner tip, wherein between the first pipe the second pipe is defined an external primary air flow feeding channel;
said nozzles of circular cross-section being arranged within an inscribed area which is externally bounded by a radius external circumference which is tangent to a radially outermost point of each one of the nozzles, and internally bounded by a radius inner circumference which is tangent to a radially innermost point of each one of the nozzles, wherein, in said inscribed area, the rate between the open area Ao of the nozzles and the closed area Ac is limited to: 0.12<Ao/Ac<0.27; wherein the open area Ao corresponds to the sum of the areas of each one of the nozzles multiplied by the number of nozzles of the burner head and the closed area Ac corresponds to the inscribed area minus the open area.

2. The burner according to claim 1, wherein the rate between the nozzles open area Ao and the closed area Ac is limited to: 0.19<Ao/Ac<0.25.

3. The burner according to claim 1, wherein the burner comprises an expansion joint arranged in the region between the end upstream the second pipe and a flange.

4. The burner according to claim 1, wherein the burner comprises an expansion joint arranged in the region between the end upstream the first pipe and a flange.
